(19) United States
(12) Patent Application Publication
(10) Pub. No.: US 2025/0215244 A1
(43) Pub. Date: Jul. 3, 2025

(54) MATTING AGENT FOR POWDER COATINGS AND ITS APPLICATION, AND A MATTE POWDER COATING AND ITS APPLICATION

(71) Applicant: A.H.A INTERNATIONAL CO.,LTD., Hefei (CN)

(72) Inventors: Hao ZHANG, Hefei (CN); Chengcheng ZHAO, Hefei (CN); Qi ZHAO, Hefei (CN); Zhuoheng LI, Hefei (CN); Bin XU, Hefei (CN); Naibin TONG, Hefei (CN)

(73) Assignee: A.H.A INTERNATIONAL CO.,LTD., Hefei (CN)

(21) Appl. No.: 18/784,995

(22) Filed: Jul. 26, 2024

(30) Foreign Application Priority Data
Dec. 27, 2023 (CN) 202311831282.5

(51) Int. Cl. C09D 7/42; C09D 5/03; C09D 7/63; C09D 7/65; C09D 177/00

(52) U.S. Cl. CPC C09D 7/42; C09D 5/032; C09D 7/63; C09D 7/65; C09D 177/00

(57) ABSTRACT

A matting agent for powder coatings and its application, and a matte powder coating and its application are disclosed. The matting agent for powder coatings includes a hydroxyl functional component and a carboxyl functional component, the matting agent can achieve the matting effect of HAA powder coatings with <30% gloss (60°); the resin selectivity of the matting agent is low, and a good matting effect can be realized when used in combination with different carboxyl film-forming resins; and the matting effect of the matting agent is stable, and the prepared matte powder coating can obtain a stable matting effect under different curing conditions.

### CROSS-REFERENCE TO THE RELATED APPLICATIONS

This application is based upon and claims priority to Chinese Patent Application No. 202311831282.5, filed on Dec. 27, 2023, the entire contents of which are incorporated herein by reference.

### TECHNICAL FIELD

The present disclosure relates to the technical field of powder coatings, in particular relates to a matting agent for powder coatings and its application, and a matte powder coating and its application.

### BACKGROUND

The HAA powder coating refers to a powder coating formula with carboxyl polyester as the main film-forming resin and a class of hydroxyalkylamide compounds as the curing agent. Wherein, hydroxyalkylamide compounds can be synthesized by alkyl ester compounds and corresponding amino alcohol compounds, the alkyl ester compounds include dimethyl adipate, diethyl adipate, methyl benzoate, etc., and the amino alcohol compounds include diethanolamine, diisopropanolamine, etc. The synthesis process can be carried out using solvents or under solvent-free conditions. Patents of invention U.S. Pat. No. 5,101,073, EP0473380B1, DE19823925, CN1160311C, CN1315785C, U.S. Pat. Nos. 5,101,073A, 6,235,933B1, US20040260123A1, CN1042739C, etc., disclosed the synthesis of the described hydroxyalkylamide compounds. The powder coatings prepared with the described hydroxyalkylamide compounds as the curing agents are mostly high-gloss powder coatings, such as patent of invention U.S. Pat. No. 6,767,479B1. Patent of invention U.S. Pat. No. 6,767,479B1 disclosed a mixture of hydroxyalkylamide curing agents and a powder coating prepared from it, wherein the composition of the mixture of hydroxyalkylamide curing agents comprising a tetrafunctional hydroxyalkylamide compound and a bifunctional, and the obtained powder coating had a gloss of >90% (60°). This shows that the powder coating prepared by using a bifunctional hydroxyalkylamide compounds together with tetrafunctional hydroxyalkylamide compounds as curing agents is a high-gloss powder coating composition.

HAA powder coatings can easily achieve high gloss, but in some areas where low-gloss powder coatings are needed, such as aluminum profiles, automotive parts, agricultural machinery, metal fences, hardware, lamps, etc., as far as the current technology is concerned, it is difficult for HAA powder coatings to meet the needs of low gloss because the esterification rate of carboxyl polyester resin and hydroxyalkylamide curing agent cannot be adjusted.

Acrylic resin is a commonly used raw material for the preparation of matte powder coatings. The acrylic resins used for the preparation of matte powder coatings are mostly carboxyl acrylic resin and glycidyl acrylate acrylic resin (GMA resin), there is no hydroxyl functional polyacrylic resins for the preparation of matte powder coatings, especially for the preparation of matte HAA powder coatings.

Patents of invention CN113621263A and CN114621617A both used carboxyl acrylic acid and glycidyl acrylate acrylic resin (GMA resin) to prepare matting additives and realize the matting effect of HAA powder coatings, wherein the matting additives were based on acrylic resin, polyacid, accelerator, synthetic wax, etc., and the acrylic resin includes a GMA resin and a carboxyl acrylic resin. The HAA matting solutions disclosed in patents of invention CN113621263A and CN114621617A could stably achieve the matting effect of <10%, and no hydroxyl functional components were found, especially the application of hydroxyl acrylic resin in matte HAA powder coatings.

Patent of invention CN101880490B disclosed a matting hardener, a powder coating containing matting hardener and uses thereof, wherein the matting hardener was a polymer component polymerized by carboxyl monomers and base monomers, and the described matting hardener was a carboxyl acrylic resin, all of which had an acid value was ≥118 mgKOH/g; and the carboxyl monomers were selected from monobutyl itaconate, itaconic acid, acrylic acid, methacrylic acid and butenoic acid in one or more, the matting hardener could realize the HAA powder coating of medium gloss (20%-30%) and relatively flat film.

Patent of invention U.S. Ser. No. 10/517,064 disclosed a semi-gloss powder coating composition, which was composed of carboxyl polyester, glycidyl acrylate acrylic resin (GMA resin) and a curing agent that could react with the polyester carboxyl. The described composition could be used to realize the semi-gloss matting effect of HAA powder coatings.

The carboxyl groups in the polyacid can also undergo a cross-linking reaction with the hydroxyalkylamide curing agent in HAA powder coating, therefore, it is theoretically possible to use the polyacid to participate in the chemical cross-linking process of hydroxyalkylamide compounds. For example, patents of invention CN113621263A, CN114621617A and CN103694766A. The described polyacid (anhydride) compounds were used to prepare the matte HAA powder coating. The polyacid (anhydride) included pyromellitic acid (dianhydride), long-chain dibasic acid, trimesic acid, etc. and all of described polyacid (anhydride) matting solutions require the use of glycidyl acrylate acrylic resin to react with described polyacid (anhydrides) to achieve matting purposes polyacidpolyacid. That is to say, in the described polyacid (anhydride) matting solution, the described matte HAA powder coating will undergo cross-linking reactions with different reaction rates during the cross-linking process, so as to realize the matting effect of the described matte HAA powder coating, and the cross-linking reactions in the described matte HAA powder coating include the reaction of carboxyl groups with epoxy groups, and the reaction of carboxyl groups with hydroxyalkyl amides in two completely different reaction courses.

Patent of invention CN100491445C disclosed an ester amide condensation product as a matting agent for powder coatings, wherein the ester amide condensation product synthesized a substance with a special structure by a tetrafunctional O-hydroxyalkylamide compound combining a polyacid (anhydride) compound, realizing a matting effect of powder coatings. When the matte powder coating was a polyester-Primid powder coating, only 52% (60°) of gloss could be achieved.

At present, it is difficult to achieve the desired matte HAA powder coatings through the above matting methods. Therefore, it is necessary to develop a matting solution for HAA powder coatings with a stable matting effect, adjustable gloss and low resin selectivity.

### SUMMARY

The object of the present disclosure is to provide a matting agent for powder coatings and its application, a matte powder coating and its application, wherein the matting agent can achieve 5%-30% gloss effect of HAA powder coatings, and the matting effect is stable and the resin selectivity is low.

In order to achieve the above mentioned objects of the invention, the present disclosure provides the following technical solutions:

The present disclosure provides a matting agent for powder coatings, comprising the following components in mass percent:
a hydroxyl functional component is 50%-86%, and a carboxyl functional component is 14%-50%;
the hydroxyl functional component includes hydroxyl functional compounds 30%-62% and hydroxyl functional polyacrylic resins 38%-70%;
the hydroxyl functional compounds are hydroxyalkylamide compounds with a functionality ≥2; and
a carboxyl functionality of the carboxyl functional component is >2; and the carboxyl functional component includes one or more of carboxyl functional compounds, carboxylates and carboxy functional polyacrylic resins.

Preferably, hydroxyl functional compounds have a structure described in Formula 1

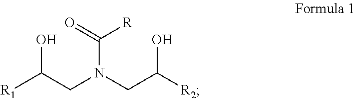

wherein, R is an alkyl, aryl, or olefinic group containing 1 to 60 carbon atoms; R₁ is a hydrogen or an alkyl group containing 1 to 5 carbon atoms, R₂ is a hydrogen or an alkyl group containing 1 to 5 carbon atoms;
or R has a structure shown in Formula 2:

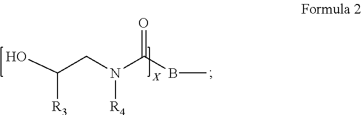

and
wherein, B is an alkyl, aryl, or olefinic containing 1 to 60 carbon atoms, R₃ is a hydrogen or an alkyl group containing 1 to 5 carbon atoms, R₄ is a hydrogen, an alkyl group containing 1 to 5 carbon atoms or a hydroxyalkyl group containing 1 to 5 carbon atoms, and X=0 to 2 and X is an integer

Preferably, a weight-average molecular weight of hydroxyl functional polyacrylic resins is 4000-1500000, a hydroxyl value is 10 mgKOH/g-150 mgKOH/g, and a glass transition temperature is 40° C.-145° C.

Preferably, carboxyl functional compounds include one or more of the following: pyromellitic acid, ethylenediaminetetraacetic acid, benzenetricarboxylic acid, butanetetracarboxylic acid, propane tricarboxylic acid, cyclohexane tetracarboxylic acid, pyromellitic acid dianhydride and trimellitic anhydride; carboxylates include pyromellitic acid-2-phenylimidazoline salt or trimellitic acid imidazoline salt; a weight-average molecular weight of carboxy functional polyacrylic resins is 2000-8000, a range of acid value is 150 mgKOH/g-300 mgKOH/g, a glass transition temperature is 40° C.-110° C., and a softening point is 80° C.-150° C.

The present disclosure provides an application of the matting agent for powder coatings described in the technical scheme in the powder coating.

The present disclosure provides a matte powder coating, and the raw materials for the preparation of which include: carboxyl polyester resins, hydroxyalkylamide curing agents, matting agents and additives agents; a mass of the carboxyl polyester resins is 40%-60% of the total mass of the matte powder coating; a mass of the matting agents is 4%-10% of the total mass of the matte powder coating; a mass ratio of the hydroxyalkylamide curing agents to carboxyl polyester resins is (4-6):(94-96); and the matting agent is a matting agent for powder coatings described in the above technical scheme.

Preferably, an acid value range of the carboxyl polyester resins is 10 mg KOH/g-100 mg KOH/g, and a glass transition temperature is 40%-80° C.

Preferably, the carboxyl polyester resins are synthesized by condensation of dibasic acids and polyols; the dibasic acids include terephthalic acid, isophthalic acid, 1,4-cyclohexyldicarboxylic acid, adipic acid, maleic acid or succinic acid; and polyols include ethylene glycol, diethylene glycol, propylene glycol, hexanediol, neopentyl glycol, cyclohexyl dimethyl alcohol or trimethylolpropane.

Preferably, hydroxyalkylamide curing agents have a structure shown in Formula 3:

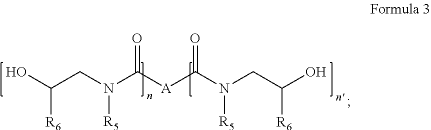

and
wherein, A is a hydrogen, an alkyl, aryl, or olefinic group containing 1 to 60 carbon atoms, R₅ is a hydrogen, an alkyl containing 1 to 5 carbon atoms or hydroxyalkyl containing 1 to 5 carbon atoms, R₆ is a hydrogen or a methyl, n′ is an integer of 0-2, n is an integer of 1-10.

The present disclosure provides an application of the matte powder coating described in the above technical scheme in the field of low-gloss powder coating, and a gloss of the low-gloss powder coating is 5%-30%.

The present disclosure provides a matting agent for powder coatings, including a hydroxyl functional component and a carboxyl functional component, and it is not restricted by any reaction theory. The hydroxyl functional component and the carboxyl functional component of the matting agent of the present disclosure undergo an esterification reaction, and this esterification reaction rate is different from that of the reaction rate of the carboxy polyester resin with the hydroxylalkylamide compounds in the HAA powder coating, and a certain reaction rate difference can be formed by the two different esterification reactions, and this reaction rate difference is the reason why the present disclosure can realize the excellent matting effect of HAA powder coating. The matting agent disclosed in the present disclosure does not have the cross-linking reaction between the epoxy and the carboxyl, which distinguishes it from the matting solution of HAA powder coating that adopts the glycidyl acrylate acrylic resin (GMA resin). In addition, the matting agent described in the present disclosure does not require the synthesis of a new special structural substance to realize the matting effect of the HAA powder coating.

The matting agent described in the present disclosure has the following beneficial effects:

1, The described matting agent can achieve a matting effect of 30% gloss (60°) for HAA powder coatings; specifically, the described matting agent can be adjusted by adjusting the dosage of the matting agent in order to achieve a gloss adjustment of 5%-30% for HAA powder coatings;

2, The described matting agent resin has low selectivity and can realize good matting effect when used with different carboxyl functional film-forming resins;

3, The matting effect of the described matting agent is stable, and the prepared matte powder coating is capable of obtaining stable matting effect under different curing conditions; and

4, The described matting agent can be produced by a one-shot method to produce matte HAA powder coatings, the operation is simple.

### BRIEF DESCRIPTION OF THE DRAWINGS

FIG. 1 is a corresponding relationship diagram between the dosage of matting agent III-5 and the gloss of powder coatings; and

FIG. 2 is the matting effect of the powder coating under different curing conditions of the powder coating prepared in Embodiment 27.

### DETAILED DESCRIPTION OF THE EMBODIMENTS

The present disclosure provides a matting agent for powder coatings, including components with a mass percentage content as follows:
a hydroxyl functional component is 50%-86%, and a carboxyl functional component is 14%-50%;
the described hydroxyl functional component includes hydroxyl functional compounds 30%-62% and hydroxyl functional polyacrylic resins 38%-70%;
the described hydroxyl functional compounds are hydroxyalkylamide compounds with a functionality ≥2; and
a carboxy functionality of the described carboxyl functional component >2; the described carboxyl functional component includes one or more of carboxy functional compounds, carboxylates and carboxy functional polyacrylic resins.

In the present disclosure, a mass percentage content of the described hydroxyl functional component is 50%-86%, preferably 70%-76%; the described hydroxyl functional component includes hydroxyl functional compounds 30%-62% and hydroxyl functional polyacrylic resins 38%-70%; a mass percentage of hydroxyl functional compounds is preferably 38.9%-40.7%, and more preferably 39.1%-40.0%, and a mass percentage of hydroxyl functional polyacrylic resins is preferably 38.9%-41.2%, and more preferably 40.0%-40.7%.

In the present disclosure, the hydroxyl functional compounds preferably have a structure described in Formula 1

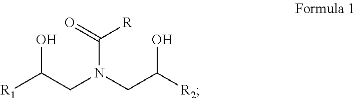

wherein, R is an alkyl, aryl, or olefinic group containing 1 to 60 carbon atoms; R₁ is a hydrogen or an alkyl with C1-5, R₂ is a hydrogen or an alkyl group containing 1 to 5 carbon atoms;
or R has a structure shown in Formula 2:

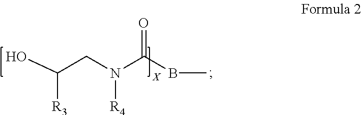

and
wherein, B is an alkyl, aryl, or olefinic group containing 1 to 60 carbon atoms, R₃ is a hydrogen or an alkyl group containing 1 to 5 carbon atoms, R₄ is a hydrogen, an alkyl group containing 1 to 5 carbon atoms or a hydroxyalkyl group containing 1 to 5 carbon atoms, and X=0 to 2 and X is an integer

In the present disclosure, R is preferably an aryl group, and further preferably a substituted or non-substituted phenyl group; R₁ and R₂ are preferably the same or different, more preferably, R₁ and R₂ are both methyl group.

In the present disclosure, the hydroxyl functional compounds are preferably:

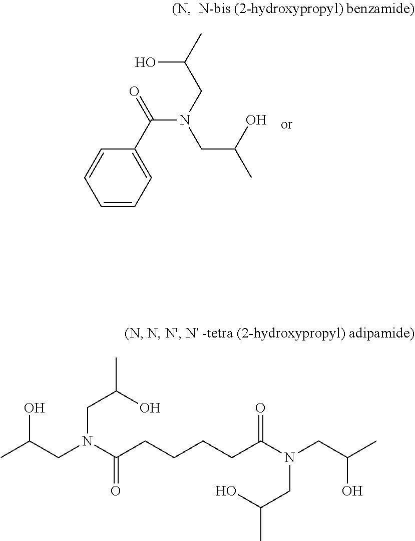 [SMILES: CC(O)CN(CC(C)O)C(=O)c1ccccc1 ; CC(O)CN(CC(C)O)C(=O)CCCCC(=O)N(CC(C)O)CC(C)O]

In the present disclosure, the hydroxyl functional compounds are preferably synthesized according to published patents of invention, for example, patents of invention US20040260123 and CN109553547A; or are purchased through the market, the specific model is no longer recounted. The hydroxyl functional compounds used in the embodiments of the present disclosure were N, N-bis(2-hydroxypropyl) benzamide and N, N, N′, N′-tetra (2-hydroxypropyl) adipamide (A.H.A INTERNATIONAL CO., LTD.)

In the present disclosure, a weight-average molecular weight of the described hydroxyl functional polyacrylic resins is preferably 4000-1500000, a hydroxyl value is preferably 10 mgKOH/g-150 mgKOH/g, and a glass transition temperature is preferably 40° C.-145° C.

In the present disclosure, the described hydroxyl functional polyacrylic resin is preferably produced by copolymerization of a hydroxyl monomer and an acrylate copolymer monomer; the described hydroxyl monomer is preferably a mixture of an allyl alcohol structural monomer and a propoxylated allyl alcohol structural monomer constituted in any ratio.

In the present disclosure, when the hydroxyl monomer is an allyl alcohol structural monomer, the general formula of structure is CH2═CY-CH2-OH, wherein Y is a hydrogen or an alkyl group containing 1 to 5 carbon atoms, preferably one or more of allyl alcohol, methyl allyl alcohol and 2-ethyl-2-propen-1-ol. When the hydroxyl-containing monomer is a propoxylated allyl alcohol structural monomer, the general formula of structure is CH2═CZ-CH2-(A)a-OH, A is an oxygen propylidene group, Z is a hydrogen or an alkyl group containing 1 to 5 carbon atoms, a is an average number of oxygen propylidene groups in propoxylated allyl alcohol, and a=1-2.

In the present disclosure, the described acrylate copolymer monomer is preferably methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, iso-butyl acrylate, iso-butyl methacrylate, t-butyl acrylate, tert-butyl methacrylate, 2-ethylhexyl acrylate, 2-ethylhexyl methacrylate, octyl acrylate, octyl methacrylate, dodecyl acrylate, dodecyl methacrylate, benzyl acrylate, benzyl methacrylate or vinyl monomers; and the vinyl monomers are preferably styrene and/or methyl styrene.

The present disclosure has no special limitation on the polymerization conditions for the copolymerization of the described hydroxyl monomers and acrylate copolymer monomers, and it is sufficient to adopt the methods of propriety polymerization, free base solution polymerization, emulsion polymerization, and suspension polymerization which are well known to the technicians in the field, and it is more preferable for free base solution polymerization, and it is preferable to add an initiator during the polymerization, and the described initiator is preferred to be azobis(iso)butanonitrile, benzoyl peroxide, tert-butylhydrogen peroxide or diisopropyl benzene peroxide.

In the present disclosure, the described hydroxy functional polyacrylic resin is preferably obtained through market purchase, and the hydroxy functional polyacrylic resin used in the present disclosure is the PChem®BM series product (Pioneer Chemicals), and other kinds of hydroxy functional polyacrylic resins are also obtained through market purchase, and the specific models will not be repeated.

In the present disclosure, a mass percentage of the described carboxyl functional component is 14% to 50%, preferably 18.7% to 22.2%, further preferably 19.8% to 20.0%.

In the present disclosure, a carboxy functionality of the described carboxyl functional component is >2; the described carboxyl functional component includes one or more of carboxy functional compounds, carboxylates and carboxy functional polyacrylic resins. When the described carboxyl functional component is one or more of the above two, the present disclosure does not have any special limitation on the ratio of different components, and any ratio is acceptable.

In the present disclosure, the described carboxyl functional compounds preferably include one or more of pyromellitic acid, ethylenediaminetetraacetic acid, benzenetricarboxylic acid, butanetetracarboxylic acid, propane tricarboxylic acid, cyclohexane tetracarboxylic acid, pyromellitic acid dianhydride and trimellitic anhydride; the carboxylates preferably include phenyltetracarboxylic acid-2-phenylimidazoline salt or trimellitic acid imidazoline salt; a weight-average molecular weight of the carboxy functional polyacrylic resin is preferably 2000-8000, more preferably 3000-7000, and further preferably 4000-6500; an acid value range is preferably 150 mgKOH/g-300 mgKOH/g, more preferably 170 mgKOH/g-280 mgKOH/g, and further preferably 200 mgKOH/g-260 mgKOH/g; a glass transition temperature is preferably 40° C.-110° C., more preferably 50° C.-100° C., and further preferably 60° C.-90° C.; and a softening point is preferably 80° C.-150° C., more preferably 90° C.-120° C., and further preferably 97° C.-115° C.

In the present disclosure, the described carboxy functional polyacrylic resin is preferably prepared by copolymerization of a carboxyl monomer and an acrylate copolymer comonomer; a mass of the carboxyl monomer is preferably 25%-40% of the total mass of the carboxyl monomer and the acrylate copolymer monomer, more preferably 30%-35%; and a mass of the acrylate copolymer comonomer is preferably 60%-75% of the total mass of the carboxyl monomer and the acrylate copolymer monomer, and more preferably 65%-70%.

In the present disclosure, a structural formula of the carboxyl monomer is shown in Formula a:

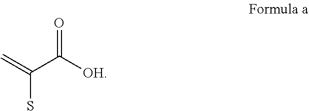

Wherein, S is preferably H, methyl, ethyl, n-propyl, isopropyl, n-butyl, isobutyl or tert-butyl.

In the present disclosure, the described acrylate copolymer comonomer is preferably methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, iso-butyl acrylate, iso-butyl methacrylate, t-butyl acrylate, tert-butyl methacrylate, 2-ethylhexyl acrylate, 2-ethylhexyl methacrylate, octyl acrylate, octyl methacrylate, dodecyl acrylate, dodecyl methacrylate, benzyl acrylate, benzyl methacrylate or vinyl monomers; and the vinyl monomers are preferably styrene and/or methyl styrene.

In the present disclosure, the described carboxy functional polyacrylic resin is preferably obtained by polymerization of a carboxyl monomer and an acrylate copolymer monomer. The present disclosure has no special limitation on the polymerization conditions, and can adopt the methods of bulk polymerization, free radical solution polymerization, emulsion polymerization and suspension polymerization which are well known in this field. The method is more preferably free radical solution polymerization, an initiator is preferably added in the polymerization process, and the initiator is preferably azodiisobutyronitrile, dibenzoyl peroxide, tert-butyl hydroperoxide or dicumyl peroxide.

In the present disclosure, the described carboxy functional polyacrylic resin is preferably obtained by market purchase, the partial carboxyl functional acrylic resins used in the present disclosure are LZ5005, LZ7007 (Baoding Lanzhu Chemical Co., Ltd.) and JONCRYL 843 (BASF); other types of carboxy functional polyacrylic resins are also purchased through the market, the specific model is no longer recounted.

The present disclosure has no special limitation on the preparation method of the matting agent for the powder coating, and the material can be mixed evenly according to the method well known in this field; and in the embodiment of the present disclosure, specifically, all the raw materials of the matting agent were ground and crushed, respectively, and then passed through a 140-mesh sieve, according to the formula composition (mass percentage) of the matting agent, all the raw materials after the crushing and sieving were dispersed evenly in a high-speed mixer, to obtain the corresponding matting agent.

The present disclosure provides an application of the matting agent for powder coatings described in the above technical solution in powder coatings.

The present disclosure provides a matte powder coating, the preparation raw materials include: carboxyl polyester resins, hydroxyalkylamide curing agents, matting agents and additives; a mass of carboxyl polyester resins is 40%-60% of the total mass of the matte powder coating; a mass of matting agents is 4%-10% of the total mass of the matte powder coating; a mass ratio of hydroxyalkylamide curing agents to the carboxyl polyester resins is (4-6):(94-96); and the matting agent is a matting agent for powder coatings described in the above technical solution.

In the present disclosure, a mass of the carboxyl polyester resins is preferably 45%-55% of the total mass of the matte powder coating, more preferably 50%-54%, and further preferably 51.9%-53.1%; a mass of the matting agents is 4%-10% of the total mass of the matte powder coating, preferably 5%-9%, and further preferably 6.7%-7.4%; and a mass ratio of the hydroxyalkylamide curing agents to the carboxyl polyester resins is preferably (4-6):(94-96), more preferably (4.5-5.5):(94.5-95.5), and further preferably (5-5.2):95.

In the present disclosure, an acid value range of the carboxyl polyester resins is preferably 10 mg KOH/g-100 mg KOH/g, more preferably 20 mg KOH/g-80 mg KOH/g, and further preferably 25 mg KOH/g-40 mg KOH/g; and a glass transition temperature is preferably 40° C.-80° C., more preferably 45° C.-65° C., further preferably 50° C.-65° C.

In the present disclosure, the carboxyl polyester resins are preferably synthesized by condensation of dibasic acids and polyols; the dibasic acids preferably include terephthalic acid, isophthalic acid, 1,4-cyclohexyldicarboxylic acid, adipic acid, maleic acid or succinic acid; and polyols preferably include ethylene glycol, diethylene glycol, propylene glycol, hexanediol, neopentyl glycol, cyclohexyl dimethyl alcohol or trimethylolpropane.

The carboxyl polyester resins of the present disclosure are preferably commodities on sale, such as Anhui Shenjian's SJ5122 and SJ5100.

In the present disclosure, the hydroxyalkylamide curing agents have a structure different from the hydroxyalkylamide compounds in the matting agent.

In the present disclosure, the hydroxyalkylamide curing agents have a structure shown in Formula 3:

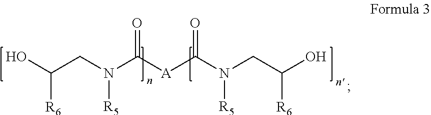

and
wherein, A is a hydrogen, an alkyl, aryl, or olefinic group containing 1 to 60 carbon atoms, R₅ is a hydrogen, an alkyl group containing 1 to 5 carbon atoms or a hydroxyalkyl containing 1 to 5 carbon atoms, R₆ is a hydrogen or a methyl, n′ is an integer of 0-2, n is an integer of 1-10.

In the present disclosure, the alkyl group containing 1 to 60 carbon atoms is preferably methyl, ethyl, propyl, butyl, amyl, hexyl, heptyl, octyl, nonyl, decyl, 20 alkyl, 30 alkyl, 40 alkyl, 50 alkyl or 60 alkyl; the aryl is preferably phenyl or naphthyl; and the olefin group is preferably vinyl, isopropenyl, 1,3-dimethyl-3-propenyl, 1,2-dimethyl-2-propenyl, 3-carboxy-2-propenyl or 3-ethoxycarbonyl-2-propenyl.

In the present disclosure, the alkyl group containing 1 to 5 carbon atoms is preferably methyl, ethyl, n-propyl, n-butyl, isobutyl, tert-butyl or pentane; and the hydroxyl alkyl with C1-5 is preferably hydroxyethyl, 3-hydroxypropyl, 2-hydroxypropyl, 4-hydroxybutyl, 3-hydroxybutyl, 2-hydroxy-2-methylpropyl, 5-hydroxyamyl, 4-hydroxyamyl, 3-hydroxyamyl or 2-hydroxyamyl.

In the present disclosure, n is preferably 1 or 2; A is preferably (CH2) m, m is an integer of 1-10, more preferably 2-8, further preferably 4.

In the present disclosure, the hydroxyalkylamide curing agent is preferably at least one of N, N, N′, N′-tetra (β-hydroxyethyl) adipamide and N, N, N′, N′-tetra (β-hydroxypropyl) adipamide; when the hydroxyalkylamide curing agent is the above two, the present disclosure has no special limitation on the ratio of the two, and can be adjusted according to the actual demand; N, N, N′, N′-tetra (β-hydroxyethyl) adipamide is preferably as a commodity on sale, such as Primid XL552 from EMS, T105 from Ningbo South Sea Chemical or VestagonHA320 from Degussa; and N, N, N′, N′-tetra (β-hydroxypropyl) adipamide is a commodity on sale, such as Primid QM 1260 from EMS.

In the present disclosure, the additives preferably include leveling agent, plasticizers, stabilizer or degassing agent; the stabilizer is preferably a stabilizer to prevent UV degradation; the degassing agent is preferably benzoin; and the present disclosure has no special limitation on the specific model and dosage of the leveling agents, plasticizer and stabilizer, and the corresponding additives known in this field can be adjusted according to the actual needs.

In the present disclosure, the component of the matte powder coating also preferably includes pigments; the pigments are preferably TiO2, iron oxide red, iron oxide yellow, chrome pigment, carbon black, phthalocyanine blue, azo, anthraquinone, thioindigo, benzoanthrone, triphenylethane or quinacridone; more preferably pigments with resistance to outdoor exposure.

The present disclosure has no special limitation on the addition ratio of the additives and pigments, and can be added to the powder coating according to the actual needs.

In the present disclosure, the described matte powder coating is preferably prepared by one-shot process: each raw material is mixed evenly, performed hot melt mixing, tableting, crushing and sieving in turn, where the mesh number is 80-200 mesh (Chinese standard sieve); preferably 100-180 mesh, more preferably 140-180 mesh.

In the present disclosure, the temperature of the melting and extrusion is preferably 90° C.-120° C.

The present disclosure has no special limitation on the specific preparation conditions of the described matte powder coating, and can be performed according to the process well known in this field; in the embodiment of the present disclosure, specifically, the raw materials of the powder coating were mixed according to the ratio (mass percentage), placed in a plastic bag for manual mixing for 3-5 min, and then added to a twin-screw test extruder (model: SLJ-30A, Yantai Donghui) for melting homogenization, tableting, cooling, then being milled into fine powder and passed through a 180-mesh standard sieve.

In the present disclosure, based on the existing theory, for HAA powder coatings, the hydroxyl in the hydroxy functional polyacrylic resin cannot undergo a cross-linking reaction with the carboxyl in the film-forming resin and the carboxyl in the matting agent, and also cannot react with the curing agent in the powder coating formula, Therefore, theoretically the addition ratio of carboxyl film-forming resin and hydroxyalkylamide curing agent in powder coating formula cannot be affected by hydroxyl acrylic resin, and the cross-linking reaction process of carboxyl and hydroxyalkylamide compounds cannot be affected by hydroxyl acrylic resin. However, in practice, the matting effect of the matting agent in the present disclosure can further be enhanced by adding hydroxy functional polyacrylic resins to the matting agent, a lower gloss matte powder coating can be obtained and the leveling performance of the matte powder coating can be improved.

The esterification of carboxyl and hydroxyl usually needs to be performed at a high temperature above 225° C. or under the action of a strong catalyst, however, in the cross-linking chemistry of hydroxyalkylamide, the reason why hydroxyalkylamide compounds can be esterified with the carboxyl of the carboxyl polyester resin is an activation effect of hydroxyl by amide in hydroxyalkylamide compounds. The activation effect can cause the hydroxyalkylamide compounds to form an oxazolium intermediate structure under heating. Then the esterification product can be obtained by the ring-opening reaction of the oxazolium intermediate and the carboxyl in the carboxyl polyester resin. However, the oxazoline ring has a special reactivity, which can undergo the ring-opening reaction with both electrophiles and nucleophiles. Therefore, the present disclosure proposes that the reaction of hydroxyl and oxazole ring may occur in the presence of the hydroxyl functional components, thus affecting the reaction rate of carboxyl group and oxazole ring, thereby generating the speed difference, in particular, the addition of hydroxyl functional polyacrylic resins can affect the ring-opening reaction process of the oxazolium intermediate and the carboxyl group. In the present disclosure, it is demonstrated that under the action of hydroxyl functional polyacrylic resins, a matte HAA powder coating with lower gloss and better leveling performance can be obtained.

The present disclosure provides an application of the matte powder coating described in the above technical solution in the field of low-gloss powder coating, the described low-gloss having a gloss of 5% to 30%.

The construction of the matte powder coating described in the present disclosure is preferably carried out by powder electrostatic gun, friction gun spraying, fluidized bed dip coating and melting sintering to make it adhere to a substrate (e.g. a metal substrate), then heating or radiantly curing to form a coating film, and the thickness of the coating is preferably selected according to the need, and more preferably 50 μm to 400 μm, and further preferably 60 μm to 80 μm.

The technical solutions provided by the present disclosure are described in detail below in connection with the embodiments, but they are not to be construed as limiting the scope of protection of the present disclosure.

### EMBODIMENT

All matting agents were prepared according to the following methods: all the raw materials of the matting agent were ground and crushed respectively, and passed through a 140 mesh sieve for use, according to the formula composition (mass percentage) of the matting agent, all the raw materials after crushing and sieving were put into a high-speed mixer to disperse evenly to obtain the corresponding matting agent.

The preparation method of powder coating was: the raw materials of the powder coating were mixed according to the ratio (mass percentage), placed in a plastic bag for manual mixing for 5 min, and then added to a twin-screw test extruder (model: SLJ-30A, Yantai Donghui) for melt homogenization at 90° C.-120° C., tableting, cooling, then being milled into fine powder and passed through a 180-mesh standard sieve, after electrostatic spraying of low gloss powder coating compositions on degreased cold rolled steel sheet, curing at 200° C. for 10 min and testing after curing.

### Performance Test Method

### 1. Film Thickness

According to the GB/T 13452.2 standard, it was measured directly by a magnetic thickness tester (the magnetic thickness tester was Q Nix4500 from Automation Dr. Nix GmbH, Germany).

### 2. Gloss

According to the GB/T 9754 standard, under the geometries of 60°, it was directly measured by Micro-glosses 60° 4442 from Germany BYK company.

### 3. Impact Strength

According to the GB/T 1732 standard, it was performed by a hammer-type impact resistance tester. Wherein 1 kg 50 cm direct and reverse impact passing marked as 50+, direct impact passing marked as 50, neither direct nor reverse impact passing marked as <50, and so on.

### 4. Leveling

PCI grading was performed with the naked eye, of which 10 was the best and 0 was the worst.

TABLE 1
Information on main raw materials used in the embodiment

| | | CAS | |
|---|---|---|---|
| Name | Category | Number | Supplier |
| N, N, N′, N′ -tetra | Hydroxylalkylamide curing | 6334-25-4 | Lu'an Jietongda New |
| (2-hydroxyethyl) | agent | | Material Co., Ltd. |
| adipamide (HAA) | | | |
| N, N-bis | Hydroxyl functional | 422278-61-3 | A.H.A |
| (2-hydroxypropyl) | compound | | INTERNATIONAL |
| benzamide | | | CO., LTD. |
| N, N, N′, N′ -tetra | Hydroxyl functional | 57843-53-5 | A.H.A |
| (2-hydroxypropyl) | compound | | INTERNATIONAL |
| adipamide | | | CO., LTD. |
| Diethanolamide | Hydroxyl functional | 68603-42-9 | Shanghai Titan |
| stearic acid | compound | | Scientific Co., Ltd. |
| BM261 | Hydroxyl functional | / | Pioneer Chemicals |
| | polyacrylic resin | | |
| BM655 | Hydroxyl functional | / | Pioneer Chemicals |
| | polyacrylic resin | | |
| BM666 | Hydroxyl functional | / | Pioneer Chemicals |
| | polyacrylic resin | | |
| BM676 | Hydroxyl functional | / | Pioneer Chemicals |
| | polyacrylic resin | | |
| Pyromellitic acid | Carboxyl functional | 89-05-4 | Shanghai Titan |
| | compound | | Scientific Co., Ltd. |
| Trimellitic | Carboxyl functional | 552-30-7 | Shanghai Titan |
| anhydride | compound | | Scientific Co., Ltd. |
| Aminotriacetic | Carboxyl functional | 556-33-2 | Shanghai Titan |
| acid | compound | | Scientific Co., Ltd. |
| Ethylenediaminetetraacetic | Carboxyl functional | 60-00-4 | Shanghai Titan |
| acid | compound | | Scientific Co., Ltd. |
| Propane | Carboxyl functional | 99-14-9 | Shanghai Titan |
| tricarboxylic acid | compound | | Scientific Co., Ltd. |
| Butanetetracarboxylic | Carboxyl functional | 1703-58-8 | Shanghai Titan |
| acid | compound | | Scientific Co., Ltd. |
| Cyclohexane | Carboxyl functional | 15383-49-0 | Shanghai Titan |
| tetracarboxylic | compound | | Scientific Co., Ltd. |
| acid | | | |
| 2-Phenyl-2-imidazoline | Carboxylate | 54553-90-1 | Huangshan Deping |
| pyromellitic | | | Chemical Co., Ltd. |
| acid | | | |
| A703 | Carboxy functional | / | Wuhan Yincai |
| | polyacrylic resin | | Technology Co., Ltd. |
| JONCRYL 843 | Carboxy functional | / | BASF |
| | polyacrylic resin | | |
| LZ-5005 | Carboxy functional | / | Baoding Lanzhu |
| | polyacrylic resin | | Chemical Co., Ltd. |
| LZ-7007 | Carboxy functional | / | Baoding Lanzhu |
| | polyacrylic resin | | Chemical Co., Ltd. |
| SA2102 | Carboxy functional | / | Lu'an Jietongda New |
| | polyacrylic resin | | Material Co., Ltd. |
| SA151 | Carboxy functional | / | Lu'an Jietongda New |
| | polyacrylic resin | | Material Co., Ltd. |
| K7510 | Carboxy functional | / | Lu'an Jietongda New |
| | polyacrylic resin | | Material Co., Ltd. |
| SJ5122 | Carboxyl polyester resin | / | Lu'an Jietongda New |
| | | | Material Co., Ltd. |
| Uralac ® P865 | Carboxyl polyester resin | / | DSM |
| CRYLCOAT | Carboxyl polyester resin | / | Allnex |
| 2630-2 | | | |
| SJ4#ET | Carboxyl polyester resin | / | Anhui Shenjian New |
| | | | Materials Co., Ltd. |
| CRYLCOAT | Carboxyl polyester resin | / | Allnex |
| 2441-2 | | | |

The matting agent was prepared by using carboxylates and hydroxyl functional compounds as raw materials, and the formula composition of the matting agent is shown in Table 2.

TABLE 2
Formula composition of matting agent I-1 and I-2

| Matting agent | I-1 | I-2 |
|---|---|---|
| 2-Phenyl-2-imidazoline pyromellitic | 54.1% | 44.4% |
| acid | | |
| N, N, N′, N′ -tetra (2-hydroxyethyl) | 45.9% | |
| adipamide | | |
| N, N-bis (2-hydroxypropyl) | | 55.6% |
| benzamide | | |
| Total | 100.0% | 100.0% |

The formula composition and application test results of matte powder coatings composed of matting agents I-1 and I-2 were shown in Table 3.

TABLE 3
Composition and test results of matte powder coatings
composed of matting agents I-1 and I-2

| | Embodiment 1 | Embodiment 2 |
|---|---|---|
| SJ5122 | 55.6% | 54.8% |
| HAA | 2.9% | 2.9% |
| Leveling agent | 1.0% | 1.0% |
| Benzoin | 0.4% | 0.4% |
| Carbon black | 0.6% | 0.6% |
| Barytes | 34.8% | 34.9% |
| EBS | 1.0% | 1.0% |
| Matting agent I-1 | 3.7% | |
| Matting agent I-2 | | 4.5% |
| Total | 100.0% | 100.0% |
| PCI | 4 | 5 |
| Film | 80-95 | 70-85 |
| thickness(μm) | | |
| Gloss % (60°) | 36.5 | 19.2 |
| Impact resistance | 50+ | 50+ |

It could be seen from Table 3, the matte powder coating prepared with matting agent I-1 (Embodiment 1) with poor leveling performance after curing, the matte powder coating prepared with matting agent I-2 (Embodiment 2) with a lower gloss and better leveling performance.

It could be seen from Embodiment 2, the combination of 2-phenyl-2-imidazoline pyromellitic acid and N, N-bis(2-hydroxypropyl) benzamide could achieve excellent matting effect of HAA powder coatings, but the leveling performance was still insufficient, and the cured coating had obvious pinhole and orange peel defects. The carboxy functional polyacrylic resin was one of the common matting agent raw materials in the field of powder coating technology. Therefore, based on matting agent I-2, carboxy functional polyacrylic resins with different acid values were added to the matting agent formula, to enhance the matting effect of the matting agent and improve the leveling performance of the layout. The composition of the new matting agent formula was shown in Table 4.

TABLE 4
Composition of matting agent II-1-II-8

| | Matting agent | | | | | | | | |
|---|---|---|---|---|---|---|---|---|---|
| | II-1 | II-2 | II-3 | II-4 | II-5 | II-6 | II-7 | II-8 | [symbol] |
| 2-Phenyl-2- | 20.3% | 20.3% | 20.3% | 20.3% | 20.3% | 22.2% | 22.2% | 22.2% | |
| imidazoline | | | | | | | | | |
| pyromellitic | | | | | | | | | |
| acid | | | | | | | | | |
| A703 | 54.1% | | | | | | | | acid |
| | | | | | | | | | value: 140 |
| JONCRYL | | 54.1% | | | | | | | acid |
| 843 | | | | | | | | | value: 200 |
| LZ-5005 | | | 54.1% | | | | | | acid |
| | | | | | | | | | value: 200 |
| LZ-7007 | | | | 54.1% | | | | | acid |
| | | | | | | | | | value: 220 |
| SA2102 | | | | | 54.1% | 59.2% | | | acid |
| | | | | | | | | | value: 120 |
| SA151 | | | | | | | 59.2% | | acid |
| | | | | | | | | | value: 150 |
| K7510 | | | | | | | | 59.2% | acid |
| | | | | | | | | | value: 170 |
| N,N,N′,N′- | | | | | | 18.6% | 18.6% | 18.6% | |
| tetra | | | | | | | | | |
| (2-hydroxy | | | | | | | | | |
| ethyl) | | | | | | | | | |
| adipamide | | | | | | | | | |
| N,N-bis | 25.7% | 25.7% | 25.7% | 25.7% | 25.7% | | | | |
| (2-hydroxy | | | | | | | | | |
| propyl) | | | | | | | | | |
| benzamide | | | | | | | | | |
| Total | 100.0% | 100.0% | 100.0% | 100.0% | 100.0% | 100.0% | 100.0% | 100.0% | |

The formula composition and application test results of the matte powder coating composed of matting agent II-1-II-8 were shown in Table 5.

TABLE 5
Composition and test results of matte powder coatings composed of matting agent II-1-II-8

| | Embodiment | Embodiment | Embodiment | Embodiment | Embodiment | Embodiment | Embodiment | Embodiment |
|---|---|---|---|---|---|---|---|---|
| | 3 | 4 | 5 | 6 | 7 | 8 | 9 | 10 |
| SJ5122 | 51.9% | 51.9% | 51.9% | 51.9% | 51.9% | 53.1% | 53.1% | 53.1% |
| HAA | 2.7% | 2.7% | 2.7% | 2.7% | 2.7% | 2.8% | 2.8% | 2.8% |
| Leveling agent | 1.0% | 1.0% | 1.0% | 1.0% | 1.0% | 1.0% | 1.0% | 1.0% |
| Benzoin | 0.4% | 0.4% | 0.4% | 0.4% | 0.4% | 0.4% | 0.4% | 0.4% |
| Carbon black | 0.6% | 0.6% | 0.6% | 0.6% | 0.6% | 0.6% | 0.6% | 0.6% |
| Barytes | 35.0% | 35.0% | 35.0% | 35.0% | 35.0% | 34.4% | 34.4% | 34.4% |
| EBS | 1.0% | 1.0% | 1.0% | 1.0% | 1.0% | 1.0% | 1.0% | 1.0% |
| Matting agent | 7.4% | | | | | | | |
| II-1 | | | | | | | | |
| Matting agent | | 7.4% | | | | | | |
| II-2 | | | | | | | | |
| Matting agent | | | 7.4% | | | | | |
| II-3 | | | | | | | | |
| Matting agent | | | | 7.4% | | | | |
| II-4 | | | | | | | | |
| Matting agent | | | | | 7.4% | | | |
| II-5 | | | | | | | | |
| Matting agent | | | | | | 6.7% | | |
| II-6 | | | | | | | | |
| Matting agent | | | | | | | 6.7% | |
| II-7 | | | | | | | | |
| Matting agent | | | | | | | | 6.7% |
| II-8 | | | | | | | | |
| Total | 100.0% | 100.0% | 100.0% | 100.0% | 100.0% | 100.0% | 100.0% | 100.0% |
| PCI | 5-6 | 5-6 | 5-6 | 5-6 | 5-6 | 5-6 | 5-6 | 5-6 |
| Film | 70-90 | 65-75 | 90-100 | 90-100 | 70-80 | 65-80 | 75-85 | 65-75 |
| thickness(μm) | | | | | | | | |
| Gloss %(60°) | 19.7 | 17.0 | 12.0 | 16.5 | 16.6 | 20.6 | 22.3 | 19.4 |
| Impact | <50 | <50 | <50 | <50 | <50 | <50 | <50 | <50 |
| resistance | | | | | | | | |

It could be seen from Embodiments 3-10, the matting agent composed of carboxy functional polyacrylic resins with different acid values, combined with 2-phenyl-2-imidazoline pyromellitic acid and N, N-bis(2-hydroxypropyl) benzamide could obtain a better matting effect, however, it could also lead to a significant deterioration of the impact resistance of the cured coating, which could not meet the actual use requirements.

In order to eliminate the influence of the carboxyl functional acrylic resin on the impact resistance of cured coatings, the hydroxyl functional polyacrylic resin was added to the matting agent formula. The hydroxyl functional polyacrylic resin was added to the matting agent formula based on matting agent I-2, that was, seven kinds of matting agents III-1-III-7 were prepared by hydroxyl functional compounds and hydroxyl functional polyacrylic resins combined with carboxylates, and the formula composition of the matting agent was shown in Table 6.

TABLE 6
Formula composition of matting agent III-1-III-7

| | Matting agent | | | | | | |
|---|---|---|---|---|---|---|---|
| | III-1 | III-2 | III-3 | III-4 | III-5 | III-6 | III-7 |
| 2-Phenyl-2-imidazoline | 20.3% | 20.3% | 20.3% | 27.8% | 27.8% | 23.8% | 30.0% |
| pyromellitic acid | | | | | | | |
| BM261 | 54.1% | | | | | | |
| BM655 | | 54.1% | | | | | |
| BM666 | | | 54.1% | | 37.0% | 31.7% | 40.0% |
| BM676 | | | | 37.0% | | | |
| N,N-bis (2-hydroxypropyl) | 25.7% | 25.7% | 25.7% | 35.2% | 35.2% | | |
| benzamide | | | | | | | |
| Diethanolamide stearic acid | | | | | | 44.4% | |
| N,N,N′,N′-tetra | | | | | | | 30.0% |
| (2-hydroxypropyl) | | | | | | | |
| adipamide | | | | | | | |
| Total | 100.0% | 100.0% | 100.0% | 100.0% | 100.0% | 100.0% | 100.0% |

The hydroxyl functional polyacrylic resins used in the above matting agent III were purchased from Pioneer Chemicals. The formula composition and application test results of matte powder coatings composed of matting agents III-1-III-7 were shown in Table 7.

TABLE 7
Formula composition and test results of matte powder coatings composed of matting agents III-1-III-7

| | Embodiment | Embodiment | Embodiment | Embodiment | Embodiment | Embodiment | Embodiment |
|---|---|---|---|---|---|---|---|
| | 11 | 12 | 13 | 14 | 15 | 16 | 17 |
| SJ5122 | 51.9% | 51.9% | 51.9% | 53.9% | 53.9% | 53.4% | 54.1% |
| HAA | 2.7% | 2.7% | 2.7% | 2.8% | 2.8% | 2.8% | 2.8% |
| Leveling agent | 1.0% | 1.0% | 1.0% | 1.0% | 1.0% | 1.0% | 1.0% |
| Benzoin | 0.4% | 0.4% | 0.4% | 0.4% | 0.4% | 0.4% | 0.4% |
| Carbon black | 0.6% | 0.6% | 0.6% | 0.6% | 0.6% | 0.6% | 0.6% |
| Barytes | 35.0% | 35.0% | 35.0% | 34.9% | 34.9% | 34.6% | 35.1% |
| EBS | 1.0% | 1.0% | 1.0% | 1.0% | 1.0% | 1.0% | 1.0% |
| Matting agent | 7.4% | | | | | | |
| III-1 | | | | | | | |
| Matting agent | | 7.4% | | | | | |
| III-2 | | | | | | | |
| Matting agent | | | 7.4% | | | | |
| III-3 | | | | | | | |
| Matting agent | | | | 5.4% | | | |
| III-4 | | | | | | | |
| Matting agent | | | | | 5.4% | | |
| III-5 | | | | | | | |
| Matting agent | | | | | | 6.2% | |
| III-6 | | | | | | | |
| Matting agent | | | | | | | 5.0% |
| III-7 | | | | | | | |
| Total | 100.0% | 100.0% | 100.0% | 100.0% | 100.0% | 100.0% | 100.0% |
| PCI | 5-6 | 5 | 5-6 | 5-6 | 5-6 | 5-6 | 5 |
| Film | 80-90 | 80-90 | 80-90 | 65-80 | 85-100 | 65-75 | 70-80 |
| thickness(μm) | | | | | | | |
| Gloss %(60°) | 17.2 | 17.5 | 16.1 | 19.6 | 16.5 | 27.9 | 28.7 |
| Impact resistance | 50 | 50 | 50 | 50 | 50 | 50 | 50 |

It could be seen from Table 7 that the matte HAA powder coatings prepared with matting agent III-1-III-7 could achieve excellent matting effect, wherein the matting agent was preferably matting agent III-5. The matting effect of 16.5% could be achieved by adding 5.400 of the matting agent III-5 used in Embodiment 15, the matting effect of matting agent III-2 with the same raw material as matting agent III-5 when the dosage of matting agent is 7.400 (Embodiment 12) was close to that of Embodiment 15, however, the leveling performance of the coating after curing in Embodiment 12 was slightly lower than that in Embodiment 15, indicating that the matting agent III-5 was a more preferred matting agent.

In addition, From the comparison of the Embodiments in Table 7 and Table 5, it could be seen that, the impact resistance of the matting agents III-1-III-7 prepared by hydroxyl functional polyacrylic resins and the coatings after curing of the matting powder prepared by hydroxyl functional polyacrylic resins were better than that of the matting agents prepared by carboxyl functional polyacrylic resins in Table 5 (comparing Embodiments 3-7 and Embodiments 11-15). It could be seen that the hydroxyl functional polyacrylic resins in the present disclosure could cooperate with 2-phenyl-2-imidazoline pyromellitic acid (carboxylate) and N, N-bis(2-hydroxypropyl) benzamide (hydroxyl functional compounds) to achieve the required matting effect of HAA powder coating, and did not affect the curing effect of the coating and the film-forming performance of the powder coating.

It could be seen from Embodiment 16 and Embodiment 17 that, diethanolamide stearic acid or N, N, N′, N′-tetra (2-hydroxypropyl) adipamide combined with 2-phenyl-2-imidazoline pyromellitic acid and hydroxyl functional polyacrylic resins could also achieve the matting effect of HAA powder coatings, its gloss was 27.9% and 28.7% respectively, and the gloss was higher than the combination of 2-phenyl-2-imidazoline pyromellitic acid, N, N-bis (2-hydroxypropyl) and hydroxyl functional polyacrylic resins (comparing Embodiments 11-15).

In addition to the above 2-phenyl-2-imidazoline pyromellitic acid, seven kinds of matting agents IV-1-IV-7 were prepared by using other polyacid (anhydride) compounds combined with N, N-bis (2-hydroxypropyl) and hydroxyl functional polyacrylic resins, and the formula composition of the matting agent was shown in Table 8.

TABLE 8
Formula composition of matting agents IV-1-IV-7

| | Matting agent number | | | | | | |
|---|---|---|---|---|---|---|---|
| | IV-1 | IV-2 | IV-3 | IV-4 | IV-5 | IV-6 | IV-7 |
| Pyromellitic acid | 19.8% | | | | | | |
| Trimellitic anhydride | | 20.0% | | | | | |
| Aminotriacetic acid | | | 20.0% | | | | |
| Ethylenediaminetetraacetic | | | | 22.2% | | | |
| acid | | | | | | | |
| Propane tricarboxylic acid | | | | | 18.7% | | |
| Butanetetracarboxylic acid | | | | | | 18.7% | |
| Cyclohexane tetracarboxylic | | | | | | | 20.0% |
| acid | | | | | | | |
| BM666 | 41.2% | 40.0% | 40.0% | 38.9% | 40.7% | 40.7% | 40.0% |
| N,N-bis (2-hydroxypropyl) | 39.1% | 40.0% | 40.0% | 38.9% | 40.7% | 40.7% | 40.0% |
| benzamide | | | | | | | |
| Total | 100.0% | 100.0% | 100.0% | 100.0% | 100.0% | 100.0% | 100.0% |

The formula composition and application test results of matte powder coatings composed of matting agents IV-1-IV-7 were shown in Table 9.

TABLE 9
Formula composition and test results of matte powder coatings composed of matting agents IV-1-IV-7

| | Embodiment | Embodiment | Embodiment | Embodiment | Embodiment | Embodiment | Embodiment |
|---|---|---|---|---|---|---|---|
| | 18 | 19 | 20 | 21 | 22 | 23 | 24 |
| SJ5122 | 54.2% | 54.1% | 54.1% | 54.0% | 54.1% | 54.1% | 54.1% |
| HAA | 2.8% | 2.8% | 2.8% | 2.8% | 2.8% | 2.8% | 2.8% |
| Leveling | 1.0% | 1.0% | 1.0% | 1.0% | 1.0% | 1.0% | 1.0% |
| agent | | | | | | | |
| Benzoin | 0.4% | 0.4% | 0.4% | 0.4% | 0.4% | 0.4% | 0.4% |
| Carbon black | 0.6% | 0.6% | 0.6% | 0.6% | 0.6% | 0.6% | 0.6% |
| Barytes | 35.1% | 35.1% | 35.1% | 35.0% | 35.1% | 35.1% | 35.1% |
| EBS | 1.0% | 1.0% | 1.0% | 1.0% | 1.0% | 1.0% | 1.0% |
| Matting agent | 4.9% | | | | | | |
| IV-1 | | | | | | | |
| Matting agent | | 5.0% | | | | | |
| IV-2 | | | | | | | |
| Matting agent | | | 5.0% | | | | |
| IV-3 | | | | | | | |
| Matting agent | | | | 5.1% | | | |
| IV-4 | | | | | | | |
| Matting agent | | | | | 4.9% | | |
| IV-5 | | | | | | | |
| Matting agent | | | | | | 4.9% | |
| IV-6 | | | | | | | |
| Matting agent | | | | | | | 5.0% |
| IV-7 | | | | | | | |
| Total | 100.0% | 100.0% | 100.0% | 100.0% | 100.0% | 100.0% | 100.0% |
| PCI | 5 | 5-6 | 5-6 | 5-6 | 5-6 | 5-6 | 5-6 |
| Film | 70-80 | 60-70 | 55-65 | 65-75 | 60-75 | 70-80 | 55-65 |
| thickness(μm) | | | | | | | |
| Gloss %(60°) | 23.7 | 35.8 | 39.9 | 37.0 | 35.1 | 22.5 | 39.1 |
| Impact | 50 | 50 | 50 | 50 | 50 | 50 | 50 |
| resistance | | | | | | | |

It could be seen from Embodiments 18-24 in Table 9, different polyacid (anhydride) compounds combined with N, N-bis (2-hydroxypropyl) and hydroxyl functional polyacrylic resins could achieve an excellent matting effect of the HAA system. However, after comparing the Embodiment 15, it could be seen the gloss of the matte powder coatings of Embodiments 18-24 was higher than that of Embodiment 15, indicating that Embodiment 15 was the best powder coating composition with the best matting effect, that was, the combination of 2-phenyl-2-imidazoline pyromellitic acid, N, N-bis (2-hydroxypropyl) and hydroxyl functional polyacrylic resins was the preferred matting agent composition, the matting agent III-5 was the preferred matting agent, and the other polyacids (anhydrides) instead of 2-phenyl-2-imidazoline pyromellitic acid had deteriorated the matting effect.

Therefore, based on the matting agent III-5, the matting effect of powder coatings with different dosages of matting agent was tested, and the test formula and test results of matte powder coatings were shown in Table 10.

TABLE 10
Formula composition and test results of matte powder coatings
with different dosages of matting agent III-5

| | Embodiment | Embodiment | Embodiment | Embodiment | Embodiment | Embodiment |
|---|---|---|---|---|---|---|
| | 25 | 26 | 27 | 28 | 29 | 30 |
| SJ5122 | 55.1% | 54.1% | 53.1% | 52.1% | 51.2% | 50.2% |
| HAA | 2.9% | 2.8% | 2.8% | 2.7% | 2.7% | 2.6% |
| Leveling agent | 1.0% | 1.0% | 1.0% | 1.0% | 1.0% | 1.0% |
| Benzoin | 0.4% | 0.4% | 0.4% | 0.4% | 0.4% | 0.4% |
| Carbon black | 35.0% | 35.1% | 35.1% | 35.1% | 35.1% | 35.1% |
| Barytes | 0.6% | 0.6% | 0.6% | 0.6% | 0.6% | 0.6% |
| EBS | 1.0% | 1.0% | 1.0% | 1.0% | 1.0% | 1.0% |
| Matting agent | 4.0% | 5.0% | 6.0% | 7.0% | 8.0% | 9.0% |
| III-5 | | | | | | |
| Total | 100.0% | 100.0% | 100.0% | 100.0% | 100.0% | 100.0% |
| PCI | 5-6 | 5-6 | 5-6 | 6 | 6 | 6 |
| Film | 75-85 | 80-90 | 70-80 | 90-100 | 85-95 | 70-80 |
| thickness(μm) | | | | | | |
| Gloss %(60°) | 26.0 | 21.6 | 17.6 | 13.8 | 9.1 | 6.6 |
| Impact resistance | 50 | 50 | 50 | 50 | 50 | 50 |

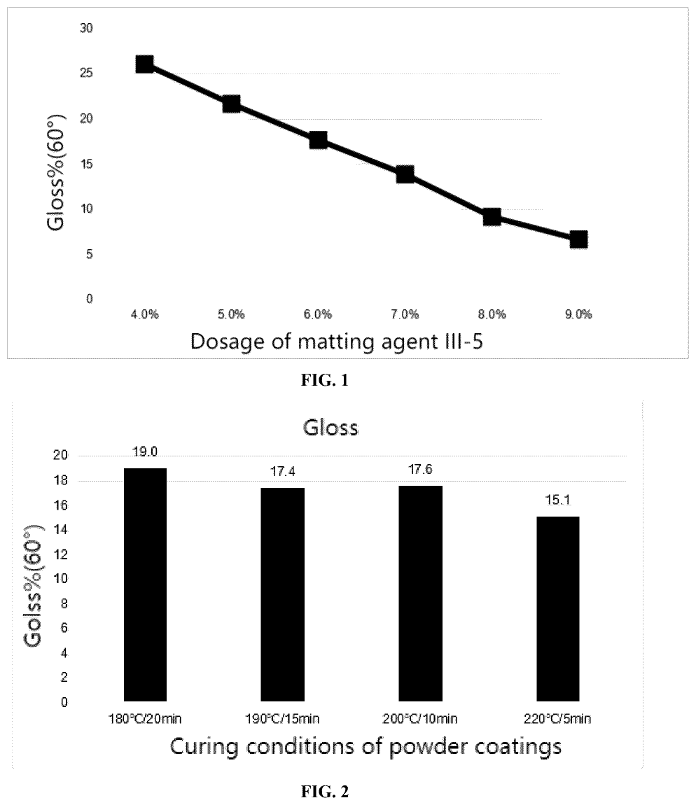

It could be seen from Table 10 that with the increase of the dosage of matting agent III-5 added in the formula, the final gloss of the powder coating would be lower and lower, and the matting effect would change linearly with the dosage of matting agent added (see FIG. 1).

The gloss of the powder coatings prepared by Embodiment 27 was tested after curing under different curing conditions, and the results were shown in FIG. 2. It could be seen from FIG. 2 that the gloss difference of powder coatings prepared with matting agent III-5 after curing under different curing conditions was not obvious, which explained that the gloss stability of the prepared powder coating was very high, and the stable extinction effect could be achieved without obvious fluctuation with the change of baking temperature. Based on the curing condition of 200° C., the gloss shift of the coating after curing was less than ±2 gloss units at different curing temperatures, and the gloss fluctuated very little with the change of baking conditions. In addition, the powder coating prepared with the matting agent III-5 can also achieve rapid curing at high temperature without affecting the matting effect of the matting agent.

### Selectivity Test for Different Polyester Resins

Matting effect of matting agent III-5 were tested with different polyester resins, the formula and test results of powder coatings were shown in Table 11.

TABLE 11
The matting effect of different polyester resins with matting agent III-5

| | Embodiment | Embodiment | Embodiment | Embodiment | |
|---|---|---|---|---|---|
| | 31 | 32 | 33 | 34 | Note |
| Uralac ® P865 | 53.1% | | | | DSM |
| CRYLCOAT 2630-2 | | 53.1% | | | Allnex |
| SJ4#ET | | | 53.1% | | Anhui |
| | | | | | Shenjian |
| CRYLCOAT 2441-2 | | | | 53.1% | Allnex |
| HAA | 2.8% | 2.8% | 2.8% | 2.8% | |
| Leveling agent | 1.0% | 1.0% | 1.0% | 1.0% | |
| Benzoin | 0.4% | 0.4% | 0.4% | 0.4% | |
| Carbon black | 35.1% | 35.1% | 35.1% | 35.1% | |
| Barytes | 0.6% | 0.6% | 0.6% | 0.6% | |
| EBS | 1.0% | 1.0% | 1.0% | 1.0% | |
| Matting agent III-5 | 6.0% | 6.0% | 6.0% | 6.0% | |
| Total | 100.0% | 100.0% | 100.0% | 100.0% | |
| PCI | 6 | 6 | 5-6 | 5-6 | |
| Film thickness(μm) | 75-85 | 90-105 | 100-110 | 85-95 | |
| Gloss % (60°) | 12.6 | 12.6 | 19.5 | 17.6 | |
| Impact resistance | 50 | 50 | 50 | 50 | |

It could be seen from Table 11 compared with Embodiment 26, HAA powder coatings formula with different polyester resins and matting agent III-5 could achieve a matting effect of less than 20%, which was a matting effect that could not be achieved by all public matting agents in the past.

In summary, the matting agent of the present disclosure can stably realize the matting of the HAA powder coating, and the gloss can be adjusted by adjusting the dosage of the matting agent, the curing conditions are broad, the resin selectivity is low, and the matting effect is stable, and it is the preferred solution to realize the matting of the HAA powder coating.

The above description is only the preferred embodiment of the present disclosure. It should be pointed out that for ordinary technical personnel in this technical field, some improvements and embellishments can be made without breaking away from the principle of the present disclosure, which should also be regarded as the protection scope of the present disclosure.

What is claimed is:

1. A matting agent for powder coatings, comprising the following components in a mass percent:
50%-86% of a hydroxyl functional component and 14%-50% of a carboxyl functional component; wherein
the hydroxyl functional component comprises 30%-62% of hydroxyl functional compounds and 38%-70% of hydroxyl functional polyacrylic resins;
the hydroxyl functional compounds are hydroxyalkylamide compounds with a functionality ≥2; and
a carboxyl functionality of the carboxyl functional component is >2; and the carboxyl functional component comprises one or more of carboxyl functional compounds, carboxylates, and carboxy functional polyacrylic resins.

2. The matting agent according to claim 1, wherein the hydroxyl functional compounds have a structure described in Formula 1: 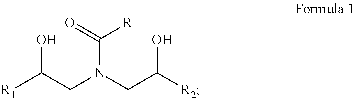
R is an alkyl, aryl, or olefinic group containing 1 to 60 carbon atoms; R₁ is a hydrogen or an alkyl group containing 1 to 5 carbon atoms, R₂ is a hydrogen or an alkyl group containing 1 to 5 carbon atoms;
or R has a structure shown in Formula 2: 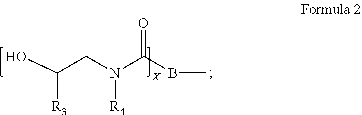
and
wherein, B is an alkyl, aryl, or olefinic containing 1 to 60 carbon atoms, R₃ is a hydrogen or an alkyl group containing 1 to 5 carbon atoms, R₄ is a hydrogen, an alkyl group containing 1 to 5 carbon atoms, or a hydroxyalkyl group containing 1 to 5 carbon atoms, and X=0 to 2, and X is an integer.

3. The matting agent according to claim 1, wherein a weight-average molecular weight of the hydroxyl functional polyacrylic resins is 4000-1500000, a hydroxyl value of the hydroxyl functional polyacrylic resins is 10 mgKOH/g-150 mgKOH/g, and a glass transition temperature of the hydroxyl functional polyacrylic resins is 40° C.-145° C.

4. The matting agent according to claim 1, wherein the carboxyl functional compounds comprise one or more of the following: pyromellitic acid, ethylenediaminetetraacetic acid, benzenetricarboxylic acid, butanetetracarboxylic acid, propane tricarboxylic acid, cyclohexane tetracarboxylic acid, pyromellitic acid dianhydride, and trimellitic anhydride; the carboxylates comprise pyromellitic acid-2-phenylimidazoline salt or trimellitic acid imidazoline salt; and a weight-average molecular weight of the carboxy functional polyacrylic resins is 2000-8000, a range of an acid value of the carboxy functional polyacrylic resins is 150 mgKOH/g-300 mgKOH/g, a glass transition temperature of the carboxy functional polyacrylic resins is 40° C.-110° C., and a softening point of the carboxy functional polyacrylic resins is 80° C.-150° C.

5. The matting agent according to claim 1, wherein the matting agent is used in the powder coatings.

6. A matte powder coating, wherein preparation raw materials comprise: carboxyl polyester resins, hydroxyalkylamide curing agents, the matting agent according to claim 1, and additives agents; a mass of the carboxyl polyester resins is 40%-60% of a total mass of the matte powder coating; a mass of the matting agent is 4%-10% of the total mass of the matte powder coating; a mass ratio of the hydroxyalkylamide curing agents to the carboxyl polyester resins is (4-6):(94-96).

7. The matte powder coating according to claim 6, wherein an acid value range of the carboxyl polyester resins is 10 mgKOH/g-100 mg KOH/g, and a glass transition temperature of the carboxyl polyester resins is 40° C.-80° C.

8. The matte powder coating according to claim 6, wherein the carboxyl polyester resins are synthesized by a condensation of dibasic acids and polyols; the dibasic acids comprise terephthalic acid, isophthalic acid, 1,4-cyclohexyldicarboxylic acid, adipic acid, maleic acid, or succinic acid; and the polyols comprise ethylene glycol, diethylene glycol, propylene glycol, hexanediol, neopentyl glycol, cyclohexyl dimethyl alcohol, or trimethylolpropane.

9. The matte powder coating according to claim 6, wherein the hydroxyalkylamide curing agents have a structure shown in Formula 3: 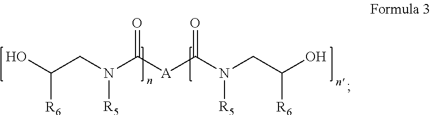
and
wherein, A is a hydrogen, an alkyl, aryl, or olefinic group containing 1 to 60 carbon atoms, R₅ is a hydrogen, an alkyl containing 1 to 5 carbon atoms, or hydroxyalkyl containing 1 to 5 carbon atoms, R₆ is a hydrogen or a methyl, n′ is an integer of 0-2, n is an integer of 1-10.

10. The matte powder coating according to claim 6, wherein the matte powder coating is used in a field of a low-gloss powder coating, wherein a gloss of the low-gloss powder coating is 5%-30%.

11. The matting agent according to claim 2, wherein the matting agent is used in the powder coatings.

12. The matting agent according to claim 3, wherein the matting agent is used in the powder coatings.

13. The matting agent according to claim 4, wherein the matting agent is used in the powder coatings.

14. The matte powder coating according to claim 6, wherein in the matting agent, the hydroxyl functional compounds have a structure described in Formula 1: 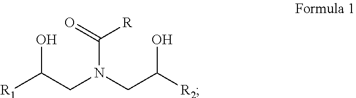
R is an alkyl, aryl, or olefinic group containing 1 to 60 carbon atoms; R₁ is a hydrogen or an alkyl group containing 1 to 5 carbon atoms, R₂ is a hydrogen or an alkyl group containing 1 to 5 carbon atoms;
or R has a structure shown in Formula 2: 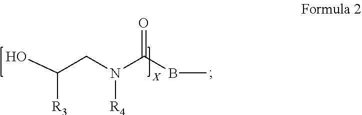
and
wherein, B is an alkyl, aryl, or olefinic containing 1 to 60 carbon atoms, R₃ is a hydrogen or an alkyl group containing 1 to 5 carbon atoms, R₄ is a hydrogen, an alkyl group containing 1 to 5 carbon atoms, or a hydroxyalkyl group containing 1 to 5 carbon atoms, and X=0 to 2, and X is an integer.

15. The matte powder coating according to claim 6, wherein in the matting agent, a weight-average molecular weight of the hydroxyl functional polyacrylic resins is 4000-1500000, a hydroxyl value of the hydroxyl functional polyacrylic resins is 10 mgKOH/g-150 mgKOH/g, and a glass transition temperature of the hydroxyl functional polyacrylic resins is 40° C.-145° C.

16. The matte powder coating according to claim 6, wherein in the matting agent, the carboxyl functional compounds comprise one or more of the following: pyromellitic acid, ethylenediaminetetraacetic acid, benzenetricarboxylic acid, butanetetracarboxylic acid, propane tricarboxylic acid, cyclohexane tetracarboxylic acid, pyromellitic acid dianhydride, and trimellitic anhydride; the carboxylates comprise pyromellitic acid-2-phenylimidazoline salt or trimellitic acid imidazoline salt; and a weight-average molecular weight of the carboxy functional polyacrylic resins is 2000-8000, a range of an acid value of the carboxy functional polyacrylic resins is 150 mgKOH/g-300 mgKOH/g, a glass transition temperature of the carboxy functional polyacrylic resins is 40° C.-110° C., and a softening point of the carboxy functional polyacrylic resins is 80° C.-150° C.

17. The matte powder coating according to claim 7, wherein the carboxyl polyester resins are synthesized by a condensation of dibasic acids and polyols; the dibasic acids comprise terephthalic acid, isophthalic acid, 1,4-cyclohexyldicarboxylic acid, adipic acid, maleic acid, or succinic acid; and the polyols comprise ethylene glycol, diethylene glycol, propylene glycol, hexanediol, neopentyl glycol, cyclohexyl dimethyl alcohol, or trimethylolpropane.

18. The matte powder coating according to claim 7, wherein the matte powder coating is used in a field of a low-gloss powder coating, wherein a gloss of the low-gloss powder coating is 5%-30%.

19. The matte powder coating according to claim 8, wherein the matte powder coating is used in a field of a low-gloss powder coating, wherein a gloss of the low-gloss powder coating is 5%-30%.

20. The matte powder coating according to claim 9, wherein the matte powder coating is used in a field of a low-gloss powder coating, wherein a gloss of the low-gloss powder coating is 5%-30%.
